(19) United States
(12) Patent Application Publication
(10) Pub. No.: US 2015/0241007 A1
(43) Pub. Date: Aug. 27, 2015

(54) LIGHTING AND/OR SIGNALING DEVICE FOR A VEHICLE COMPRISING A LENS AND A LIGHT SOURCE

(71) Applicant: Valeo Vision, Bobigny Cedex (FR)

(72) Inventors: Christophe Dubosc, Villemomble (FR); Jean-Luc Meyrenaud, Livry Gargan (FR)

(21) Appl. No.: 14/429,925

(22) PCT Filed: Sep. 20, 2013
(86) PCT No.: PCT/EP2013/069591

§ 371 Date: Mar. 20, 2015

(30) Foreign Application Priority Data
Sep. 26, 2012 (FR) 1259012

(51) Int. Cl. F21S 8/10

(52) U.S. Cl. CPC F21S 48/115; F21S 48/1225; F21S 48/2212; F21S 48/215

(57) ABSTRACT

The optical unit for a lighting and/or signaling device for a vehicle comprising
at least one source of light, such as an LED:
at least one lens having an inlet surface positioned to receive light directly from the light source; and
at least one colored element extending facing towards the inlet surface, the colored element being visible through the lens from the outside of the unit when the light source is switched off.

### CROSS-REFERENCE TO RELATED APPLICATIONS

This application is the U.S. National Phase application of PCT Application No. PCT/EP2013/069591 filed Sep. 20, 2013, which claims priority to the French application 1259012 filed on Sep. 26, 2012, which applications are incorporated herein by reference and made a part hereof.

### BACKGROUND OF THE INVENTION

1. Field of the Invention

The invention relates to lighting and/or signaling devices for motor vehicles.

2. Description of the Related Art

Previously familiar from document FR-2 778 727 is a headlamp for a vehicle which includes a filament lamp, a lens and a shield extending between the latter in such a way that one edge of the shield intercepts one part of the beam of the lamp in order to ensure that the headlamp produces a cut-off beam pattern. In addition, the shield is tinted in such a way as to be visible through the lens when the headlamp is switched off. It is thus possible to impart a particular color to the headlamp when it is switched off and to produce a stylistic effect.

Types of light sources other than a filament lamp, for example an LED, are frequently utilized today for headlamps. The indications given in this document are not applicable, however, if it is wished to achieve a corresponding stylistic effect. In fact, the design of a headlamp equipped with an LED is radically different from that of a headlamp equipped with a filament lamp.

### SUMMARY OF THE INVENTION

One object of the invention is to impart a tint to an optical unit of a lighting and/or signaling device, when the unit is in the switched-off state, thereby enabling the utilization of different types of light sources.

Proposed according to the invention for this purpose is an optical unit for a lighting and/or signaling device for a vehicle, which comprises:

at least one source of light, such as an LED,

at least one lens having an inlet surface positioned to receive light directly from the light source, and, in addition

at least one colored element extending facing towards the inlet surface, the colored element being visible through the lens from the outside of the unit when the light source is switched off.

The expression “direct light” is used to denote the light emitted by the light source, reaching the lens and not encountering any obstacle on its path between the light source and the lens.

The invention takes advantage of the fact that, in units that are fitted with a lens and with a light source such as an LED, in general the entry of light from the LED into the lens takes place via a small portion of the inlet surface so that the largest part of the latter remains unused in this respect. As a result, by making the colored element visible through the part of the inlet surface that is unused by the light beams from the light source, it is possible to impart a tint to the unit in the switched-off state without significantly disrupting the light emitted by the LED and its path through the lens. It is thus possible in a simple manner to produce a stylistic effect with the unit.

The colored element may likewise have the effect of concealing from view in whole or in part the electronic circuit for the supply of power to and the control of the one or more light sources, as the need arises.

In addition, the colored element may help to color in a marginal fashion the beam produced by the one or more light sources and without contravening the regulations.

Advantageously, the source of light and the lens are arranged in such a way that the major part of the light emitted by the light source and reaching the lens does not encounter any obstacle on its path between the source of light and the lens.

Preferably, the colored element extends facing towards the inlet surface without extending between the light source and the lens.

In one embodiment, the colored element comprises a component assembled with the lens.

In this way, the lens does not undergo any modification, and it is possible to utilize an ordinary lens to implement the invention.

At least any one of the following characterizing features may be proposed:

the colored element extends parallel to the inlet surface;

the entirety of the surface of the colored element is in contact with the inlet surface;

the colored element forms an angle with the inlet surface, in particular an angle greater than 1°, or indeed greater than 5°, and

the surface of the colored element facing towards the inlet surface is grainy.

In another embodiment, the colored element is molded onto the lens.

Advantageously, the colored element comprises a metalized layer, for example in aluminum.

Preferably, the colored element is colored by means of a varnish.

A glossy and shimmering appearance is thus imparted to the colored element, which makes it particularly visible from the outside of the unit.

Preferably, the colored element exhibits at least one window extending facing towards the at least one light source and extends all the way around the at least one window.

Advantageously, the at least one light source is positioned in the at least one window.

Advantageously, the at least one light source is set back in relation to the colored element.

According to one illustrative embodiment, the at least one light source is arranged in such a way that its light emission cone passes for the most part, or indeed in its totality, through the at least one window.

Provision can be made for the colored element to extend facing towards the entirety of the inlet surface with the exception of the at least one window.

The window may exhibit a closed or open contour, in particular a contour having three or four edges.

Preferably, the light source or at least one of the light sources exhibits an emission axis, in particular a global emission axis, for light passing through the lens.

Preferably, the light source or at least one of the light sources is arranged in order to emit a beam entering directly into the lens.

Provision can be made for the inlet surface of the lens to be plane.

Advantageously, the light source or at least one of the light sources is situated at a focus of the lens.

Advantageously, the lens exhibits a line of focuses on which the light source or at least one of the light sources is situated.

Preferably, the lens exhibits a light-emitting surface having a section of elliptical shape in at least one vertical plane.

Positioning one or a plurality of the light sources in the vicinity of one of the focuses of the ellipse is thus conducive the exit of the light beams from the lens in horizontal planes.

Preferably, the lens exhibits a light-emitting surface having a section of elliptical shape in a plurality of vertical planes that are parallel to each other.

For example, the unit is arranged in order to produce by means of the lens one part at least of a regulation lighting beam pattern with a cut-off, for example a low beam, a main beam or a fog beam.

For example, the unit is likewise arranged in order to produce by means of the lens one part at least of a regulation lighting beam pattern not exhibiting any cut-off, in particular a beam of the daytime running light type.

In one embodiment, the associated light sources that are assigned to the or each lens are at least two in number.

Also proposed according to the invention is a lighting and/or signaling device for a vehicle, which includes an optical unit according to the invention.

Advantageously, the device comprises in addition at least a second unit arranged to produce a beam supplementing a beam produced by means of the aforementioned unit in order to form a regulation lighting beam pattern.

Provision can be made for the unit to be used for lighting, for signaling or for both at the same time. Provision can likewise be made for the device to form a lighting device, a signaling device or both at the same time.

These and other objects and advantages of the invention will be apparent from the following description, the accompanying drawings and the appended claims.

### BRIEF DESCRIPTION OF THE ACCOMPANYING DRAWINGS

Other characterizing features and advantages of the invention can also be appreciated from the following description of a plurality of embodiments that is given by way of non-exhaustive example with reference to the accompanying drawings, in which:

FIGS. 1 to 3 are views respectively in perspective, from above and in cross section of a unit of a device according to a first embodiment of the invention, the cross section in FIG. 3 being considered in a horizontal plane; and

FIGS. 4 and 5 are views respectively in perspective and in vertical cross section parallel to the direction of travel of the vehicle of a unit of a device according to a second embodiment of the invention.

### DETAILED DESCRIPTION OF THE PREFERRED EMBODIMENTS

Use is made below of the orthogonal markers X, Y, Z, in which the direction Z is vertical and the directions X and Y are horizontal, the direction X being parallel to the direction of travel of the vehicle.

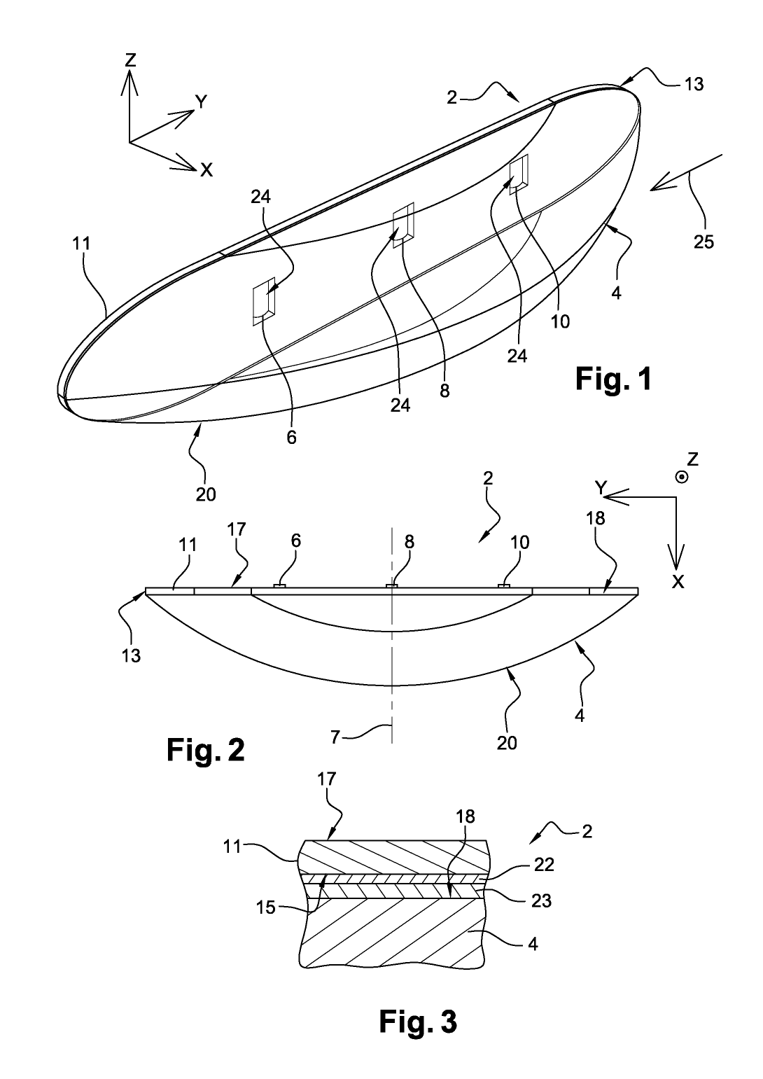

Illustrated in FIGS. 1 to 3 is a unit 2 of a lighting and signaling device for a motor vehicle according to one embodiment of the invention.

The unit 2 comprises in this particular case a single lens 4 and sources of light produced here by LEDs 6, 8, 10. The LEDs in this case are three in number, although this number is not exhaustive. It could be equal to one or two, or it could be greater than three.

The lens 4 exhibits two median planes of symmetry that are parallel respectively to the directions X and Y and to the directions X and Z.

It exhibits a vertical plane rear surface 18 perpendicular to the direction X which constitutes an inlet surface for the light from the diodes.

It exhibits a vertical front surface 20 which has an elliptical shape in vertical sections observed in planes parallel to the directions X and Z. The one of the two focuses of the ellipse which is closest to the surface 20 is situated on the surface 18. The lens 4 thus exhibits a line of focuses parallel to the direction Y and situated in its median horizontal plane. The elliptical shape, which is the same in all the sections, is supported on a curve which forms the section of the surface 20 in its horizontal median plane. This section can be given varied shapes depending on the function of the beams to be produced by the unit. The shape in this particular case is a parabolic shape. However, it could also be an elliptical shape. The lens, for example, is made from a plastic material, such as PMMA or polymethyl methacrylate. The lens 4 is molded in a colorless material.

The light sources 6,8,10 are aligned according to a straight line that is combined with the line of the focuses and is inscribed in the surface 18. Each of the light sources 6, 8, 10 is therefore situated at the aforementioned focus of the corresponding vertical section of the surface 20. All have their emitting surface in surface contact with the surface 18 so that the latter receives the light originating from each of the LEDs. Each light source 6, 8, 10 exhibits a light emission axis passing through the lens 4 and is arranged to emit a beam entering directly into the lens 4. In the present example, the light source 10 is situated on the optical axis 7 of the unit. The light source 6 is situated in the left-hand part of the lens 4, and the light source 10 in its right-hand part. Other positions of the light sources 6, 8, 10 can also be considered, of course.

The elliptical shape of the vertical sections of the surface 20 permits the light beams which emerge from the lens 4 to be oriented in horizontal planes or to be given a slightly inclined direction in relation to the horizontal direction.

The unit 2 comprises a colored element 11 formed in this particular case by a prefabricated component which is subsequently attached to the lens 4. The colored element 11 has a generally flat shape and exhibits two plane and parallel front 15 and rear 17 surfaces between them. It exhibits a free peripheral edge 13 having a shape and dimensions that are identical to those of the peripheral edge of the inlet surface 18 of the lens 4 in order to ensure that these two edges are capable of being overlaid by coming into coincidence. The two edges in the present example have an oval shape with horizontal rectilinear sections in the middle part and rounded sections at the extremities. The component or colored element 11 in this case is made from a plastic material.

In this embodiment, the front surface 15 of the component or colored element 11 is metalized, for example by means of a layer of aluminum 22 covering the entire surface. In addition, this layer is covered by a colored varnish 23, for example being red in color, although a number of other colors, such as blue and green, can also be considered. In this particular case, the component or colored element 11 is in surface contact with the inlet surface 18 via the layer of varnish 23.

The colored element 11 exhibits windows 24 associated with the respective diodes in a bijective manner. Each window 24 exhibits, in a surface view in the axis X, a polygonal shape, for example rectangular, as is the case here. Each window 24 passes through the entire thickness of the component or colored element 11 and the layers 22 and 23 in a direction parallel to the axis X. The windows 24 are positioned in order to be situated at right angles to the corresponding diodes, the latter penetrating the windows 24 as illustrated in FIG. 1. Thanks to these windows 24, the colored element 11 does not extend between the lens 4 and each of the LEDs 6, 8, 10.

The unit 2 may comprise an outer lens separating the interior and the exterior of the unit and passed through by the light beams exiting from the lens 4. The outer lens is colorless in the present example.

When the LEDs 6, 8, 10 are switched off, the colored element 11 is visible through the lens 4 by an observer who is looking at the interior of the unit being situated to one side of the exit surface 20. This observation takes place, for example, in an oblique direction 25 oriented towards the rear and towards the bottom, that is to say inclined in relation to the axes X and Z. The colored element 11 thus imparts a color to the unit 2. The color is greater in proportion to the size of the surface occupied by the colored element 11. In this particular case, it covers the majority of the inlet surface and even the entirety of the latter with the exception of the portions situated facing towards the LEDs 6, 8, 10.

In the present example, the unit 2 is equipped with means for controlling the LEDs 6,8,10 permitting one or a plurality of the LEDs 6,8,10 to be lit independently of the other or the others. In this particular case, when only the light sources 6 and 10 are lit, they produce by means of the lens 4 at least one part of a regulation lighting beam pattern not exhibiting any cut-off, in this particular case a beam of the daytime running light type. As a variant, however, it could be a cut-off lighting beam. When only the light source 8 is lit, it produces by means of the lens 4 one part at least of a regulation lighting beam pattern exhibiting or not exhibiting a cut-off.

The cut-off beam pattern is, for example, a low beam, a main beam or a fog beam.

Depending on the design of the unit and of the device, provision may be made for the unit itself to produce the entirety of the one or more beams in question or, on the other hand, for it to produce only one part of the one or more of these beams, the device comprising at least one other unit producing a beam which is intended to supplement the preceding beam in order to produce a regulation lighting beam pattern.

As the need arises, the one or more LEDs 6, 8, 10 that are not utilized for the one or more beams have another function, for example a signaling function.

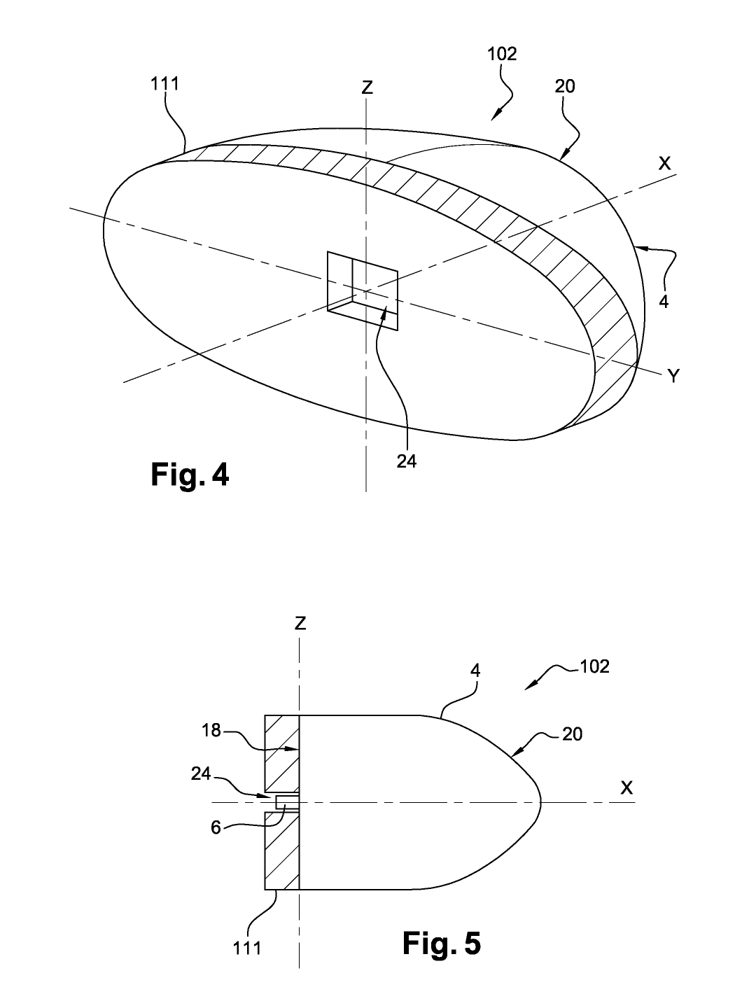

Illustrated in FIGS. 4 and 5 is a unit 102 of a lighting and/or signaling device according to another embodiment of the invention.

The unit 102 differs from the preceding unit 2 in the fact that the colored element 111 on this occasion does not form a component that is attached to the lens 4, but is molded onto the latter. It is thus secured to the lens 4 in a rigid manner from the time of its realization. The colored element 111 in this case is made from a plastic material.

Furthermore, in this embodiment, the unit 102 comprises a single LED 6 such that the colored element 111 is provided with a single window 24. In interaction with the lens 4, the LED 6 produces all or part of a regulation lighting beam pattern, which may, if necessary, be supplemented by the beam from another unit of the device.

The embodiment of the colored element 111 is nevertheless independent of the number of light sources.

The rest of the design of the unit 102 remains unchanged, as are its functionalities and the results obtained.

In each of these embodiments, when the aim is to produce a daytime running beam, the inlet surface of the lens 4 is provided with a sufficiently large surface, for example in the order of 25 cm², to obtain the regulation photometry for this type of beam pattern.

Furthermore, whether the device forms a signaling device and/or a lighting device, it may exhibit one or a plurality of lighting and/or signaling functions other than those that are implemented with the invention, the functions being realized by one or a plurality of units that are independent of the aforementioned units.

Numerous modifications may, of course, be made to the invention without going beyond the scope thereof.

The invention may be implemented with a colored element 11, 111 covering only three quarters, half or even one quarter of the surface of the inlet surface of the lens 4.

Provision may be made for the unit to comprise at least two associated lenses, each being assigned to one or a plurality of respective light sources. The two lenses may constitute separate components or one single component.

Embodiments in which the colored element 11, 111 is attached to the lens 4 are described above. The invention may nevertheless be implemented with a colored element 11, 111 which extends integrally at a distance from the lens 4.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. An optical unit for a lighting and/or signaling device for a vehicle, wherein it comprises:
at least one source of light, such as an LED;
at least one lens having an inlet surface positioned to receive light directly from said at least one light source; and
at least one colored element extending facing towards the inlet surface, said at least one colored element being visible through said at least one lens from the outside of said optical unit when said at least one light source is switched off.

2. The optical unit as claimed in claim 1, in which said at least one source of light and said at least one lens are arranged in such a way that the major part of the light emitted by said at least one light source reaching said at least one lens does not encounter any obstacle on its path between said at least one source of light and said at least one lens.

3. The optical unit as claimed in claim 1, in which said at least one colored element extends facing towards said inlet surface without extending between said at least one light source and said at least one lens.

4. The optical unit as claimed in claim 1, in which said at least one colored element comprises a component assembled with said at least one lens.

5. The optical unit as claimed in claim 1, in which said at least one colored element extends parallel to said inlet surface.

6. The optical unit as claimed in claim 1, in which the entirety of the surface of said at least one colored element is in contact with said inlet surface.

7. The optical unit as claimed in claim 1, in which said at least one colored element is molded onto said at least one lens.

8. The optical unit as claimed in claim 1, in which at least one colored element is colored by means of a varnish.

9. The optical unit as claimed in claim 1, in which said at least one colored element exhibits at least one window extending facing towards said at least one light source and extends all the way around said at least one window.

10. The optical unit as claimed in claim 9, in which said at least one light source is positioned in said at least one window.

11. The optical unit as claimed in claim 9 in which said at least one light source is set back in relation to said at least one colored element.

12. The optical unit as claimed in claim 9, in which said at least one colored element extends facing towards the entirety of said inlet surface with the exception of said at least one window.

13. The optical unit as claimed in claim 1, in which said at least one light source exhibits an emission axis, in particular a global emission axis, for light passing through said at least one lens.

14. The optical unit as claimed in claim 1, in which said at least one light source is situated at a focus of said at least one lens.

15. The optical unit as claimed in claim 1, in which said at least one light source that is assigned to said at least one lens are at least two in number.

16. A lighting and/or signaling device for a vehicle, wherein it includes an optical unit as claimed in claim 1.

17. The optical unit as claimed in claim 2, in which said at least one colored element extends facing towards said inlet surface without extending between said at least one light source and said at least one lens.

18. The optical unit as claimed in claim 2, in which said at least one colored element extends parallel to said inlet surface.

19. The optical unit as claimed in claim 3, in which said at least one colored element extends parallel to said inlet surface.

20. The optical unit as claimed in claim 2, in which said at least one colored element is colored by means of a varnish.
